(19) United States
(12) Patent Application Publication
(10) Pub. No.: US 2026/0059426 A1
(43) Pub. Date: Feb. 26, 2026

(54) METHOD FOR PROCESSING INFORMATION, COMMUNICATION DEVICE AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 19/103,715

(22) PCT Filed: Aug. 16, 2022
(86) PCT No.: PCT/CN2022/112885

§ 371 Date: Feb. 13, 2025

(51) Int. Cl. H04W 40/24; H04W 40/22; H04W 88/04

(52) U.S. Cl. CPC H04W 40/246; H04W 40/22; H04W 88/04

(57) ABSTRACT

A method for processing information, including: transmitting, to a user equipment (UE), information of a recommended UE-to-network (U2N) relay.

### CROSS-REFERENCE TO RELATED APPLICATIONS

The present application is a U.S. National Stage of International Application No. PCT/CN2022/112885, filed on Aug. 16, 2022, the contents of all of which are incorporated herein by reference in their entireties for all purposes.

### BACKGROUND OF THE INVENTION

With the deployment of 5G, cellular coverage and network connectivity are still expected to be improved, especially in some indoor, outdoor and mobile scenarios.

### SUMMARY OF THE INVENTION

The present disclosure relates to, but not limited to, the field of wireless communication technologies. Embodiments of the present disclosure provide a method for processing information, a communication device and a storage medium.

A first aspect of embodiments of the present disclosure provides a method for processing information. The method is performed by a first network device, and includes:
transmitting, to a user equipment (UE), information of a recommended UE-to-network (U2N) relay.

A second aspect of embodiments of the present disclosure provides a method for processing information. The method is performed by a user equipment (UE), and includes:
receiving information of a recommended UE-to-network (U2N) relay, where the recommended U2N relay is configured for the UE to select a target U2N relay.

A third aspect of embodiments of the present disclosure provides a method for processing information. The method is performed by a candidate user equipment-to-network (U2N) relay, and includes: monitoring a solicitation message, where the solicitation message includes information of a recommended U2N relay; and returning a response message in response to determining the candidate U2N relay is the recommended U2N relay based on the solicitation message.

A fourth aspect of embodiments of the present disclosure provides a communication device. The communication device includes one or more processors, a transceiver, a memory, and an executable program stored in the memory and runnable on the one or more processors, where the one or more processors, when running the executable program, are collectively configured to implement the method for processing information provided by any one of the first aspect.

A fifth aspect of embodiments of the present disclosure provides a communication device. The communication device includes one or more processors, a transceiver, a memory, and an executable program stored in the memory and runnable on the one or more processors, where the one or more processors, when running the executable program, are collectively configured to implement the method for processing information provided by any one of the second aspect.

A sixth aspect of embodiments of the present disclosure provides a communication device. The communication device includes one or more processors, a transceiver, a memory, and an executable program stored in the memory and runnable on the one or more processors, where the one or more processors, when running the executable program, are collectively configured to implement the method for processing information provided by any one of the third aspect.

It should be understood that the general description and the following detailed description are only exemplary and illustrative, and not intended to limit the embodiments of the present disclosure.

### BRIEF DESCRIPTION OF DRAWINGS

The drawings herein are incorporated into the description and constitute a part of the present description, show embodiments that are consistent with the present disclosure, and are used together with the description to explain the principles of the embodiments of the present disclosure.

FIG. 1 is a schematic structural diagram of a wireless communication system according to an example.

FIG. 2A is a schematic flowchart of a method for processing information shown according to an example.

FIG. 2B is a schematic flowchart of a method for processing information shown according to an example.

FIG. 2C is a schematic flowchart of a method for processing information shown according to an example.

FIG. 2D is a schematic flowchart of a method for processing information shown according to an example.

FIG. 2E is a schematic flowchart of a method for processing information shown according to an example.

FIG. 2F is a schematic flowchart of a method for processing information shown according to an example.

FIG. 2G is a schematic flowchart of a method for processing information shown according to an example.

FIG. 2H is a schematic flowchart of a method for processing information shown according to an example.

FIG. 2I is a schematic flowchart of a method for processing information shown according to an example.

FIG. 3 is a schematic flowchart of a method for processing information shown according to an example.

FIG. 4A is a schematic flowchart of a method for processing information shown according to an example.

FIG. 4B is a schematic flowchart of a method for processing information shown according to an example.

FIG. 4C is a schematic flowchart of a method for processing information shown according to an example.

FIG. 4D is a schematic flowchart of a method for processing information shown according to an example.

FIG. 5A is a schematic flowchart of a method for processing information shown according to an example.

FIG. 5B is a schematic flowchart of a method for processing information shown according to an example.

FIG. 6 is a schematic flowchart of a method for processing information shown according to an example.

FIG. 7 is a schematic structural diagram of a device for processing information shown according to an example.

FIG. 8 is a schematic structural diagram of a device for processing information according to an example.

FIG. 9 is a schematic structural diagram of a device for processing information according to an example.

FIG. 10 is a schematic structural diagram of a device for processing information according to an example.

FIG. 11 is a schematic structural diagram of UE according to an example.

FIG. 12 is a schematic structural diagram of a communication device shown according to an example.

### DETAILED DESCRIPTION OF THE INVENTION

The embodiments will be described in detail herein, and examples thereof are shown in the accompanying drawings. When the following description involves the accompanying drawings, unless otherwise indicated, the same numbers in different accompanying drawings indicate the same or similar elements. The implementations described in the following examples are not all the implementations consistent with the embodiments of the present disclosure. On the contrary, these implementations are simply examples of devices and methods consistent with some aspects of the embodiments of the present disclosure.

The terms used in the embodiments of the present disclosure are for the purpose of describing particular embodiments only and are not intended to limit the embodiments of the present disclosure. The singular forms “a/an”, “the” and “said” used in the present disclosure are intended to include the plural forms as well, unless the context clearly indicates otherwise. It should also be understood that the term “and/or” as used herein includes any and all combinations of one or more related listed items.

It should be understood that, although the terms “first”, “second”, “third”, etc., may be used to describe various information in the embodiments of the present disclosure, these should not be limited to these terms. These terms are only used to distinguish information of the same type from each other. For example, “first information” may also be referred to as “second information” without departing from the scope of the embodiments of the present disclosure. Similarly, “second information” may also be referred to as “first information”. Depending on the context, the words “if” as used here may be interpreted as “in the event of . . . ” or “when . . . ” or “in response to determining”.

In order to expand network coverage in areas that cannot be covered by Uu cells or areas where the signal quality of Uu cells is poor, it is necessary to deploy a user equipment to network (U2N) relay. In this way, UEs that cannot obtain network coverage or have poor signal quality may access a 3Gpp network via U2N relays and obtain communication services.

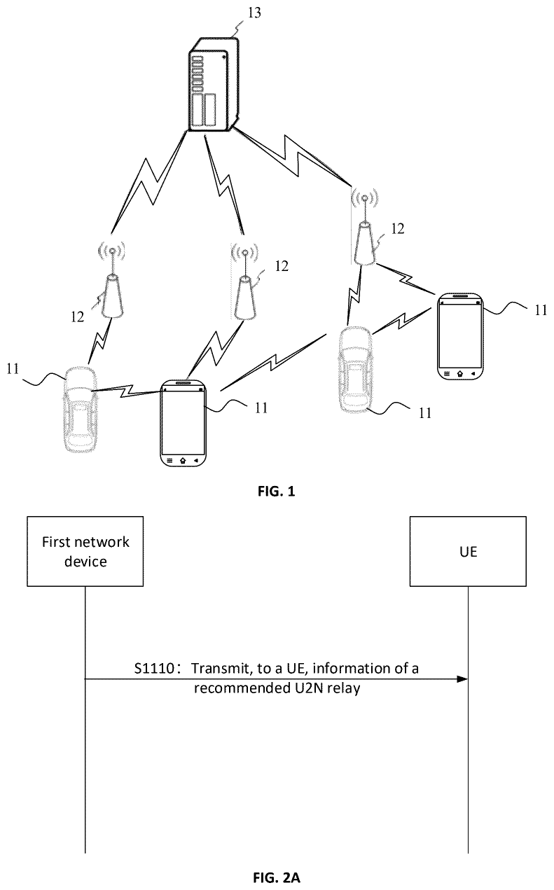

FIG. 1 illustrates a schematic structural diagram of a wireless communication system provided in an embodiment of the present disclosure. As shown in FIG. 1, the wireless communication system is a communication system based on a cellular mobile communication technology. The wireless communication system may include a plurality of user equipment (UEs) 11, a plurality of access devices 12, and a network management device 13.

The plurality of access devices 12 are connected with the network management device 13. The network management device 13 may be a core network device in the wireless communication system, for example, the network management device 13 may be a mobility management entity (MME) in an evolved packet core (EPC). Or, the network management device 13 may also be other core network devices, such as a serving gateway (SGW), a public data network gateway (PGW), a policy and charging rules function (PCRF) or a home subscriber server (HSS). The implementation form of the network management device 13 is not limited in the examples of the present disclosure.

The UE 11 may refer to a device that provides voice and/or data connectivity for a user. The UE 11 may communicate with one or more core networks via a radio access network (RAN). The UE 11 may be an Internet of Things (IoT) UE, such as a sensor device, a mobile phone (or a “cellular” phone) and a computer with the IoT UE, for example, may be a fixed, portable, pocket-sized, handheld, or a device mounted in a computer or vehicle. For example, the UE 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the UE 11 may also be a device for an unmanned aerial vehicle. Alternatively, the UE 11 may also be a vehicle-mounted device, for example, may be a trip computer with a wireless communication function, or a wireless communication device connected to an external trip computer. Alternatively, the UE 11 may also be a roadside device, such as a street lamp, a signal lamp or other roadside devices with a wireless communication function.

The access device 12 may be a network-side device in the wireless communication system. The wireless communication system may be a 4th generation mobile communication (4G) system, also known as a long term evolution (LTE) system; or the wireless communication system may also be a 5G system, also known as a new radio (NR) system or 5G NR system. Alternatively, the wireless communication system may be a next generation of the 5G system. An access network in the 5G system may be referred to as a new generation-radio access network (NG-RAN), or an MTC system.

The access device 12 may be an evolved access device (eNB) adopted in a 4G system. Alternatively, the access device 12 may also be an access device (gNB) with a centralized distributed architecture in the 5G system. The access device 12 generally includes a central unit (CU) and at least two distributed units (DU) when adopting the centralized distributed architecture. The central unit is provided with a protocol stack of a packet data convergence protocol (PDCP) layer, a radio link control (RLC) protocol layer, and a media access control (MAC) layer; and the distributed unit is provided with a protocol stack of a physical (PHY) layer. The particular implementation of the access device 12 is not limited in the embodiments of the present disclosure.

A wireless connection may be established between the access device 12 and the UE 11 via a radio interface. In different implementations, the radio interface is based on a 4th generation mobile communication network technology (4G) standard; or the radio interface is based on a 5th generation mobile communication network technology (5G) standard. For example, the radio interface is a new radio interface; or the radio interface may also be a radio interface based on a next generation mobile communication network technology standard of 5G.

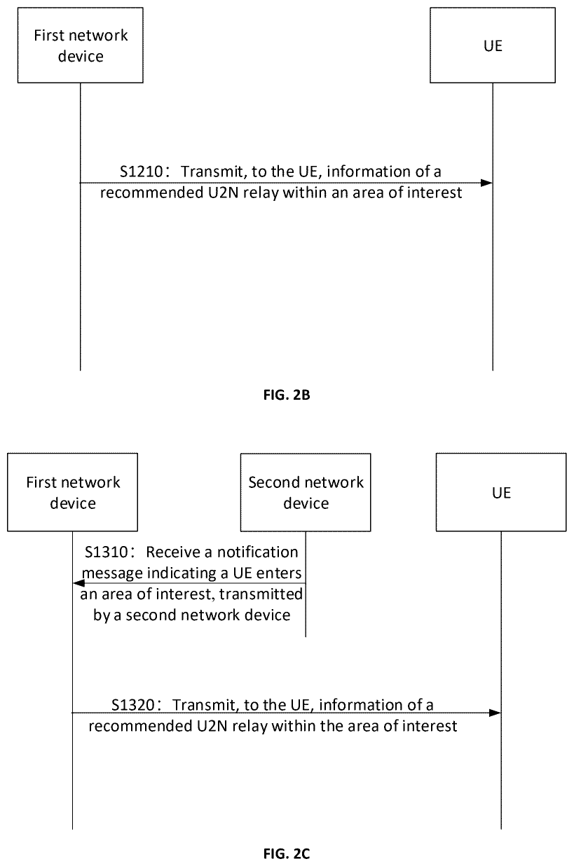

As shown in FIG. 2A, an embodiment of the present disclosure provides a method for processing information. The method is performed by a first network device, and includes step S1110.

S1110: transmitting, to UE, information of a recommended U2N relay.

The first network device may be a core network device. The core network device includes, but is not limited to, policy control function (PCF) or unified data repository (UDR).

In some embodiments, the first network device may be a core network device; the UDR stores the information of the recommended U2N relay, and the PCF may request the information of the recommended U2N relay to the UDR before transmitting, to the UE, the information of the recommended U2N relay, and transmit, to the UE, the requested information of at least part of the recommended U2N relays.

The information of the recommended U2N relay is: information of the U2N relay that is recommended for use. The quality of the provided relay service can be ensured by the recommended U2N relay, and/or the service continuity can be improved by reducing the switch of U2N relays to improve the user experience.

The information of the recommended U2N relay may include: any information capable of uniquely identifying the U2N relay, such as user information identifier (user info ID) of the recommended U2N relay.

In some embodiments, the information of the recommended U2N relay further includes, but is not limited to: device type information of the recommended U2N and/or home information of the U2N relay. The type information may indicate the mobility of the recommended U2N relay. For example, the recommended U2N relay may include: a portable recommended U2N relay and/or a fixed recommended U2N relay. The attribute information may include whether the recommended U2N relay belongs to a communications operator, or a privately established U2N relay with high signal sensitivity.

The recommended U2N relay may include a relay UE or a relay device dedicated to relaying.

For example, the first network device may transmit the information of the recommended U2N relay to the UE via one or more intermediate network devices. For example, the relay network device may include one or more core network devices and/or an access network device. The access network device includes, but is not limited to, an evolved base station (eNB) and/or a next-generation base station (gNB).

According to the technical solutions provided in the embodiments of the present disclosure, the first network device may provide, for the UE, the information of the recommended U2N relay, such that the remote UE may select the target U2N relay by reference to the recommended U2N relay, and the UE may select a target U2N relay with higher communication quality and higher stability to provide a relay service.

By transmitting the information of the recommended U2N relay, a reference may be provided for the remote UE to select a target U2N relay, so that the remote UE may select an appropriate U2N relay to ensure the quality of the relay service. For example, the target U2N relay is a relay device that is ultimately configured for communication between the remote UE and the network device.

As shown in FIG. 2B, an embodiment of the present disclosure provides a method for processing information. The method is performed by a first network device, and includes step S1210.

S1210: transmitting, to the UE, information of a recommended U2N relay within an area of interest.

In an embodiment, when the UE is within the area of interest, the information of the recommended relay may be transmitted to the UE; and when the UE is outside the area of interest, the information of the recommended U2N relay may not be transmitted to the UE.

The area of interest may be an area where the remote UE may have a relay service requirement. An area outside the area of interest may be an area with a good network coverage, or there is no area of the recommended U2N relay, so the remote UE does not need the information of the recommended U2N relay.

Therefore, the information of the recommended U2N relay within the area of interest may be transmitted to the UE only when the UE is within the area of interest, thereby reducing the network signaling overhead and the recommendation accuracy.

There may be one or more areas of interest. For example, when the current UE is within an nth area of interest, the information of the recommended U2N relay within the nth area of interest may be transmitted to the UE. The n may be any positive integer.

In another embodiment, the area of interest may be an area of interest of the UE. The UE may be currently located outside the area of interest, but the first network device may predict that the UE is about to enter the area of interest based on a movement trajectory of the UE or a requirement of the UE itself. In this way, the first network device may transmit, to the UE, the information of the recommended U2N relay within the area of interest of the UE.

As shown in FIG. 2C, an embodiment of the present disclosure provides a method for processing information. The method is performed by a first network device, and includes steps S1310 and S1320.

S1310: receiving a notification message transmitted by a second network device indicating UE enters an area of interest.

S1320: transmitting, to the UE, information of a recommended U2N relay within the area of interest.

The second network device may also be a core network device. For example, the core network device may include, but is not limited to, an access management function (AMF).

The second network device may manage the mobility of the UE, so that the UE will know whether it enters the area of interest after traveling.

The second network device may transmit a notification message to the first network device when the UE enters the area of interest, so that the first network device may receive the notification message in a case where the UE entering the area of interest. In this case, if the first network device receives the notification message, it can be known that the UE enters the area of interest and the information of the recommended U2N relay may be transmitted to the UE.

For example, the notification message may further include: area information of the area of interest where the UE enters, where the area information may include at least an area identifier.

In an embodiment, the area identifier may include an area of interest number.

In another embodiment, the area identifier may be identified based on information of a geographic location identified in a 3GPP network. For example, the area identifier may be: a cell identifier, a cell group identifier, a base station identifier, a base station group identifier, and/or a tracking area (TA) identifier, etc.

If the first network device receives the notification message indicating the UE enters the area of interest, from the second network device, the first network device may deliver the information of the recommended U2N relay to the UE in a timely manner when the UE enters the area of interest.

As shown in FIG. 2D, an embodiment of the present disclosure provides a method for processing information. The method is performed by a first network device, and includes steps S1410 and S1420.

S1410: receiving a notification message indicating a change in the area of interest where the UE is located, transmitted by a second network device.

S1420: transmitting, to the UE, information of the recommended U2N relay within the area of interest.

In some cases, the second network device may also transmit a notification message to the first network device when the area of interest where the UE is located is updated, so that the first network device may know the change in the area of interest where the UE is located in a timely manner. In this way, the information of the recommended U2N relay is transmitted to the UE in a timely manner after the change in the area of interest where the UE is located.

As shown in FIG. 2E, an embodiment of the present disclosure provides a method for processing information. The method is performed by a first network device, and includes steps S1510 and S1520.

S1510: receiving a notification message indicating a user equipment (UE) enters an area of interest and a change in the area of interest where the UE is located.

S1520: transmitting, to the UE, information of a recommended U2N relay within the area of interest.

In the embodiment, the first network device may receive the notification message indicating the UE enters the area of interest and/or the change in the area of interest where the UE is located. In this way, the UE may transmit the information of the recommended U2N relay in a timely manner when the UE enters the area of interest or the area of interest changes.

In some embodiments, the method further includes: receiving a notification message indicating the UE leaves the area of interest, transmitted by the second network device.

As shown in FIG. 2F, an embodiment of the present disclosure provides a method for processing information. The method is performed by a first network device, and includes steps S1610-S1630.

S1610: receiving location information of the UE, transmitted by a second network device.

S1620: determining whether the UE is located in the area of interest based on the location information.

S1630: transmitting, to the UE, information of a recommended U2N relay within the area of interest.

The first network device may receive the location information of the UE from the second network device and, based on the location information of the area of interest stored locally by the first network device, determine whether the UE enters or leaves the area of interest in combination with the information of the UE and the location information of the area of interest. In the embodiment of the present disclosure, the first network device may determine whether the UE is located in the area of interest by itself, and the first network device may also transmit, to the UE, the information of the recommended U2N relay within the corresponding area of interest when the UE enters the area of interest and/or the area of interest changes.

As shown in FIG. 2G, an embodiment of the present disclosure provides a method for processing information. The method is performed by a first network device and includes step S1710.

S1710: transmitting a subscription request to the second network device, where the subscription request is configured to subscribe the second network device to location information of the UE, a notification message indicating the UE has entered the area of interest, and/or a notification message indicating a change in the area of interest where the UE is located.

The subscription request may subscribe the second network device such as PCF to the location information of the UE, the notification message indicating the UE enters the area of interest, the notification message indicating the change in the area of interest where the UE is located, and/or a notification message indicating the UE leaves the area of interest.

The subscription request may include a subscription indication configured to indicate location information of the UE that is located by the first network device relative to the second network device, a notification message indicating the UE enters the area of interest, or a notification message indicating the change in the area of interest.

In an embodiment, the subscription request may further include an identifier of the UE. The identifier of the UE may include: SUCI, SUPI or other identifiers.

In another embodiment, the subscription request may further include an area identifier of the area of interest of the UE.

By transmitting the subscription request, the second network device may automatically inform the first network device of the changed location information and/or notification message of the UE, thereby facilitating the first network device to perform relevant processing.

In other embodiments, the first network device may receive trigger information of a trigger event transmitted by other network devices such as the second network device. After receiving the trigger information, the first network device requests the location information and/or notification message of the UE from the second network device, and then determines whether the information of the recommended U2N relay that is transmitted to the UE needs to be updated based on the location information and/or notification message of the UE.

In some embodiments, the area of interest is identified by at least one of: a cell identifier; a base station identifier; or a tracking area identifier.

In other embodiments, the area of interest may further be identified by at least one of: a cell group identifier, where a cell group corresponding to the cell group identifier includes one or more cells; a base station group identifier, where a base station group corresponding to the base station group identifier includes one or more base stations; or a tracking area group identifier, where a tracking area group corresponding to the tracking area group identifier includes one or more tracking areas.

As shown in FIG. 2H, an embodiment of the present disclosure provides a method for processing information. The method is performed by a first network device, and includes step S1810.

S1810: transmitting, to the UE, policy information including the information of the recommended U2N relay.

The policy information may include a policy and charging control (PCC) rule recommended for a relay service of the UE. The information of the recommended U2N relay may be carried under the PCC rule and transmitted to the remote UE authorized to acquire a U2N relay service.

For example, the U2N relay service has different service types, and different service types have different relay service codes (RSC). The relay services indicated by the different RSCs may have different recommended U2N relays, or the relay services indicated by the different RSCs may have the same recommended U2N relay. In this case, the policy information may further include the RSCs of the corresponding relay services.

In this way, the information of the recommended U2N relay may be transmitted to the UE without additional dedicated signaling, so that the quantity of signaling entries and the signaling overhead are reduced compared with the fact that the information of the recommended U2N relay is transmitted by using the dedicated signaling.

As shown in FIG. 2I, an embodiment of the present disclosure provides a method for processing information. The method is performed by a first network device, and includes step S1910.

S1910: transmitting, to UE, a list of recommended U2N relays, where the list includes information of one or more recommended U2N relays.

There may be one or more recommended U2N relays within one area of interest. In the embodiment of the present disclosure, the information of the recommended U2N relay is transmitted in the form of a list to the UE that is authorized to acquire the U2N relay.

The list includes information of one or more recommended U2N relays, and the information of the recommended U2N relay includes, but is not limited to, an identifier of the recommended U2N relay, etc.

In some embodiments, the recommended U2N relay may include at least one of: a U2N relay deployed by a communication operator; or a U2N relay recommended by the communication operator.

The U2N relay deployed by the communication operator may usually ensure that the U2N relay provides a relay service with good signal quality based on geographical location mapping, signal testing or the like; or the signal sensitivity of the recommended U2N relay is high enough to ensure the communication quality.

An ownership of the U2N relay deployed by the communication operator may belong to the communication operator or to a cooperation partner of the communication operator.

In some scenarios, a relay device (e.g., relay UE) with high antenna sensitivity is not deployed by the communication operator, but may be recommended by the communication operator because of its good signal quality, and thus also belongs to the recommended U2N relay.

In some embodiments, the UE has a permission as remote UE.

In some embodiments, transmitting, to the UE, the information of the recommended UE-to-network (U2N) relay may include: transmitting, to the UE, the information of the recommended U2N relay when UE policy association is established; and/or transmitting, to the UE, the information of the recommended U2N relay when the UE policy establishment is updated.

Establishing UE policy association is a sub-process of UE registration to a network, which mainly involves a process of the PCF delivering policy information to the AMF and then the AMF transmitting the policy information to the UE.

Updating the UE policy establishment mainly involves a process of PCF delivering policy information to the AMF and then the AMF transmitting the policy information to the UE.

In the embodiment of the present disclosure, the UE has a permission as a remote UE. That is, the information of the recommended U2N relay needs only to be transmitted to the UE that has a permission to act as the remote UE, thereby reducing unnecessary information transmission and information interferences to the UE.

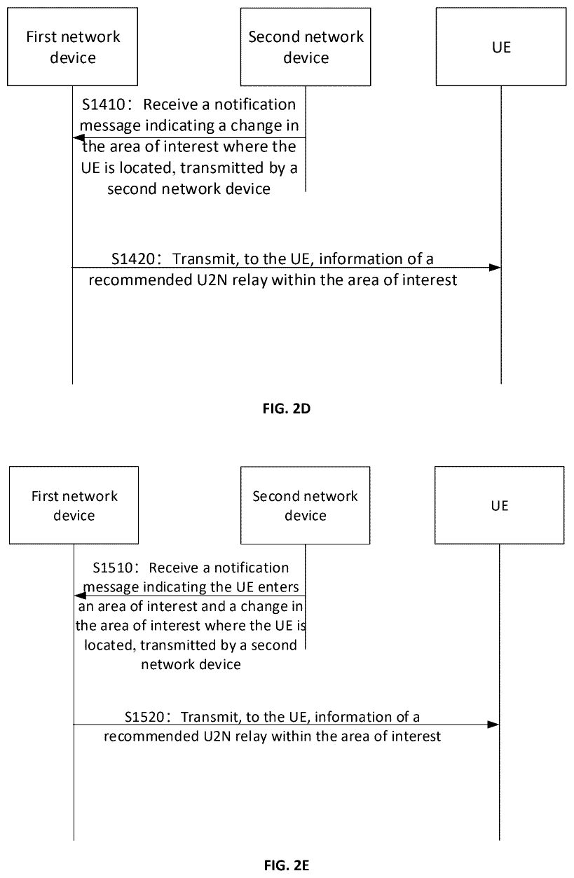

As shown in FIG. 3, an embodiment of the present disclosure provides a method for processing information. The method is performed by a second network device, and includes steps S2110 and S2120.

S2110: receiving a subscription request from a first network device.

S2120: transmitting, to the first network device, location information of a user equipment (UE), a notification message indicating the UE enters an area of interest, or a notification message indicating a change in the area of interest where the UE is located, where the location information of the UE, the notification message indicating the UE enters the area of interest or the notification message indicating the change in the area of interest where the UE is located are configured for the first network device to provide, for the UE, information of a recommended U2N relay.

The second network device may be a core network device, including but not limited to an AMF.

In the embodiment of the present disclosure, the second network device may receive the subscription request transmitted by the first network device, such that the location information of the UE is transmitted to the first network device in a case where detecting a location change of the UE that satisfies a preset condition.

The location change that satisfies the preset condition includes: a distance between the UE locations before and after the location change being greater than a preset value. Here is only an example, and the particular implementation is not limited to the example.

In the embodiment of the present disclosure, the second network device may further transmit the notification message to the first network device in response to determining, based on the subscription request, the change in the area of interest where the UE is located and/or the UE enters the area of interest from an area outside the area of interest.

The subscription request may subscribe the second network device (e.g., AMF) to the location information of the UE, the notification message indicating the UE enters the area of interest, the notification message indicating the change in the area of interest where the UE is located, and/or the notification message indicating the UE leaves the area of interest.

The subscription request may include a subscription indication configured to indicate the location information of the UE located by the first network device relative to the second network device, the notification message indicating the UE enters the area of interest, or the notification message indicating the change in the area of interest.

In an embodiment, the subscription request may further include an identifier of the UE. The identifier of the UE may include: SUCI, SUPI or other identifiers.

In another embodiment, the subscription request may further include an area identifier of the area of interest of the UE.

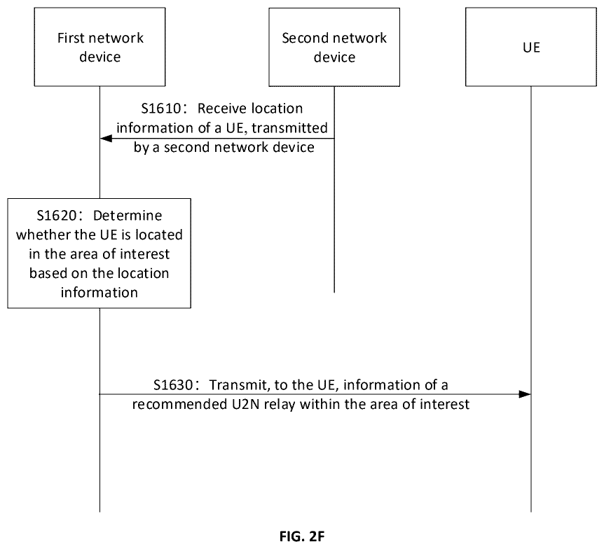

As shown in FIG. 4A, an embodiment of the present disclosure provides a method for processing information. The method is performed by UE, and includes step S3110.

S3110: receiving information of a recommended U2N relay, where the recommended U2N relay is configured for the UE to select a target U2N relay.

In the embodiment of the present disclosure, the UE may receive the information of the recommended U2N relay transmitted by the network device, so that the information of the recommended U2N relay may be referred when the target U2N relay is selected later.

For example, the UE may be a remote UE that is authorized to use a U2N relay service.

In this way, in a case where receiving the information of the recommended U2N relay, an appropriate target U2N relay may be selected based on the information of the recommended U2N relay, thereby improving the service quality of the relay service and/or the user experience.

As shown in FIG. 4B, an embodiment of the present disclosure provides a method for processing information. The method is performed by a UE, and includes steps S3110-S3230

S3110: receiving information of a recommended UE-to-network (U2N) relay.

S3220: broadcasting a solicitation message, where the solicitation message includes information of the recommended U2N relay.

S3230: receiving a response message returned by the recommended U2N relay based on the solicitation message.

In the embodiment of the present disclosure, the remote UE may transmit a solicitation message on a broadcast channel of a sidelink (SL) by using a mode B, and the solicitation message may carry the information of the recommended U2N relay transmitted on a network side, such that a response to the recommended U2N relay of the solicitation message may be monitored without triggering other response (i.e., a response message) around the UE.

If the UE only receives the response message from the recommended U2N relay, the target U2N relay of the remote UE is inevitably selected from the recommended U2N relay, while the recommended U2N relay has high quality of service and high stability, thereby improving the communication quality.

The solicitation message may be a message broadcast by the UE on a broadcast channel of the SL for mutual discovery between the remote UE and the U2N relay.

As shown in FIG. 4C, an embodiment of the present disclosure provides a method for processing information. The method is performed by a UE, and includes steps S3310-S3340.

S3310: receiving information of a recommended UE-to-network (U2N) relay.

S3320: broadcasting a solicitation message, where the solicitation message includes information of the recommended U2N relay.

S3330: receiving a response message returned by the recommended U2N relay based on the solicitation message.

S3340: selecting the recommended U2N relay transmitting the response message as the target U2N of the UE, in a case where receiving the response message.

If there is a recommended U2N relay around the UE, the UE may receive the response message returned by the recommended UN2 relay after the UE broadcasts the solicitation message. Unless the UE successfully receives the response message returned by the recommended U2N relay, the response message cannot be received.

If the UE successfully receives the response message returned by the recommended U2N relay, one or more of the U2N relays that return the response message may be selected to be used as the target U2N relay.

If the UE fails to receive the response message, it may be deemed that there is no recommended U2N relay in the vicinity of the UE, and the UE broadcasts the solicitation message that does not carry the information of the recommended U2N relay, so that a non-recommended U2N relay may be used to provide a relay service.

For example, if the UE fails to receive the response message returned by the recommended U2N relay within a predetermined duration during which the solicitation message is broadcast, or if the UE fails to receive the response message returned by the recommended U2N relay after a predetermined number of broadcasting the solicitation message, it may be determined that there is no recommended U2N relay around the UE, or the current recommended U2N relay is busy or the signal quality is not good enough to provide the U2N relay, etc.

As shown in FIG. 4D, an embodiment of the present disclosure provides a method for processing information. The method is performed by a UE, and includes steps S3410-S3430.

S3410: receiving information of a recommended UE-to-network (U2N) relay.

S3420: monitoring an announcement message broadcast by a candidate U2N relay, where the announcement message includes information of the candidate U2N relay.

S3430: selecting the target U2N relay based on the information of the candidate U2N relay and the information of the recommended U2N relay.

In some embodiments, after receiving the information of the recommended U2N relay, the UE may monitor a broadcast channel of a sidelink (SL). There may be an announcement message broadcast by the candidate U2N relay on the broadcast channel. The announcement message may include the information of the candidate U2N relay.

In order to preferably select the recommended U2N relay as the target U2N relay, in a case where receiving the announcement message, the information of the candidate U2N relay may be extracted from the announcement message and compared with the information of the recommended U2N relay. If the candidate U2N relay that transmits the announcement message includes the recommended U2N relay, the recommended U2N relay may be preferably selected as the target U2N relay to be used.

For example, if the candidate U2N relay that transmits the announcement message does not include the recommended U2N relay, the UE may select the target U2N relay based on wireless parameters of the respective candidate U2N relays. The wireless parameters include, but are not limited to, information such as signal intensity of the announcement message, and/or a load rate provided by the candidate U2N relay.

In some embodiments, selecting the target U2N relay based on the information of the candidate U2N relay and the information of the recommended U2N relay includes: selecting the candidate U2N relay included in the recommended U2N relay as the target U2N of the UE.

The UE receives the information of the recommended U2N relay and locally saves the information of the recommended U2N relay, such that the UE may refer to the information of the recommended U2N relay to select the target U2N relay when needing to use the relay service.

An embodiment of the present disclosure provides a method for processing information. The method is performed by a UE, and includes: receiving information of a recommended UE-to-network (U2N) relay; broadcasting a solicitation message; receiving a response message, where the response message includes information of a candidate U2N relay; and selecting the candidate U2N relay included in the recommended U2N relays as the target U2N of the UE.

The UE may use mutual discovery between a mode B and the candidate U2N relay. However, instead of carrying the information of the recommended U2N relay in the solicitation message, the response message transmitted by the candidate U2N relay may carry its own information. In this way, after receiving the response message, the remote UE may preferentially select the recommended U2N relay to be used as the target U2N relay based on the comparison between the information of the candidate U2N relay carried by the response message and the information of the recommended U2N relay, while no recommended U2N relay returns the response message. The remote UE may select other non-recommended U2N relay as the target U2N relay according to any random or pre-configured policy.

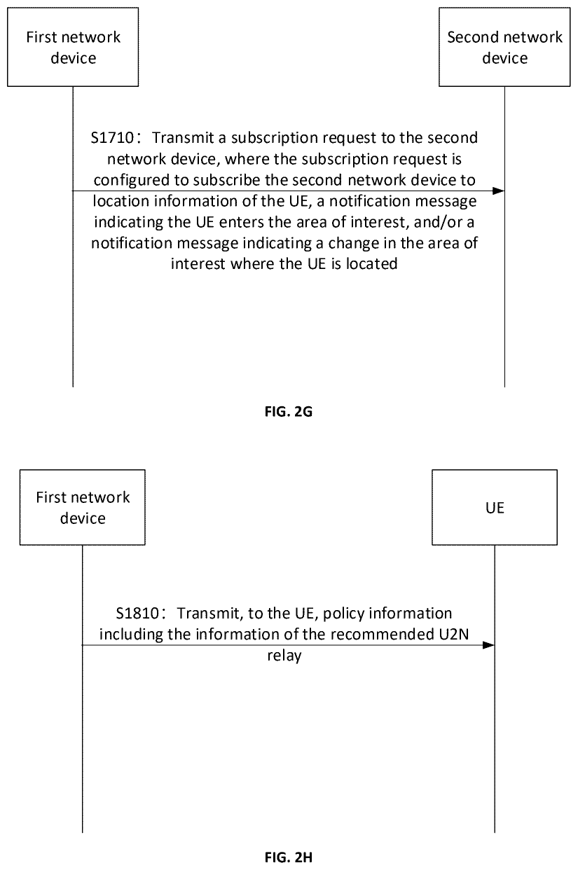

As shown in FIG. 5A, an embodiment of the present disclosure provides a method for processing information. The method is performed by a candidate UE-to-network (U2N) relay, and includes steps S4110 and S4120.

S4110: monitoring a solicitation message, where the solicitation message includes information of a recommended U2N relay.

S4120: returning a response message in response to determining the candidate U2N relay is the recommended U2N relay based on the solicitation message.

The candidate U2N relay may monitor the solicitation message on a broadcast channel if the solicitation message includes the information of the recommended U2N relay. If the information of the recommended U2N relay carried in the received solicitation message includes the information of the candidate U2N relay, a response message is returned on the broadcast channel. If the response message is returned, it indicates that the candidate U2N relay is the recommended U2N relay of the remote UE and may be preferably selected by the remote UE as a target U2N relay.

As shown in FIG. 5B, an embodiment of the present disclosure provides a method for processing information. The method is performed by a UE-to-network (U2N) relay, and includes steps S4210 and S4220.

S4210: monitoring a solicitation message, where the solicitation message includes information of a recommended U2N relay.

S4220: discarding the solicitation message in response to determining the candidate U2N relay is the recommended U2N relay based on the solicitation message.

The candidate U2N relay may monitor the solicitation message on a broadcast channel if the solicitation message includes the information of the recommended U2N relay. If the information of the recommended U2N relay carried in the received solicitation message does not include the information of the candidate U2N relay, the candidate U2N relay directly discards the solicitation message, that is, no response message is returned to the remote UE, so that the remote UE may preferably select the recommended U2N relay to be used as the target U2N relay.

A communication operator or a transport company may also deploy U2N relays on vehicles or at fixed locations. When a passenger in a vehicle connects to a 5G network using a vehicle-mounted U2N relay, there is no need to re-select the U2N relay even when traveling.

It is assumed that a 5G ProSe U2N relay deployed by an operator or a vertical company is more capable than a general UE in terms of cellular network coverage, power supply, the capability of Layer-2 5G ProSe U2N relay/Layer-3 5G ProSe U2N relay support, the fixed or predictable mobility pattern, etc. Therefore, they should be recommended to be selected.

Similarly, a user of the remote UE may prefer to use a U2N relay service provided by a known UE. For example, a UE held nearby by a user's friend, or a pre-configured UE in a particular place (e.g., a coffee bar), etc., is used as the U2N relay of the remote UE. Since the user has a better insight of service usage, expected QoS and charging rate, mobility, etc., user's proactive choices should also be considered.

The selection of the U2N relay may consider at least one of the following cases.

Whether to authorize a certain UE to use a 5G ProSe U2N relay (UE-to-network relay) in a certain PLMN. During authorized use, the authorization time, authorization location, and/or authorized service may be considered. The certain UE may acquire a relay service provided by the U2N relay only when it is at the authorization location and during the authorization time. If a network device further differentiates services when authorizing the UE, the UE may only acquire authorization for the relay service.

In a mode A, the candidate U2N relay discovers a discovery message type, U2N relay information and RSCs received in the announcement message.

In a mode B, the UE actively broadcasts a solicitation message. The solicitation message may include: the information of the recommended U2N relay. In this way, a device that receives the solicitation message may check whether it is the recommend U2N relay. If so, a response message is returned, otherwise no response message is returned. The UE receives the response message from the recommended U2N relay.

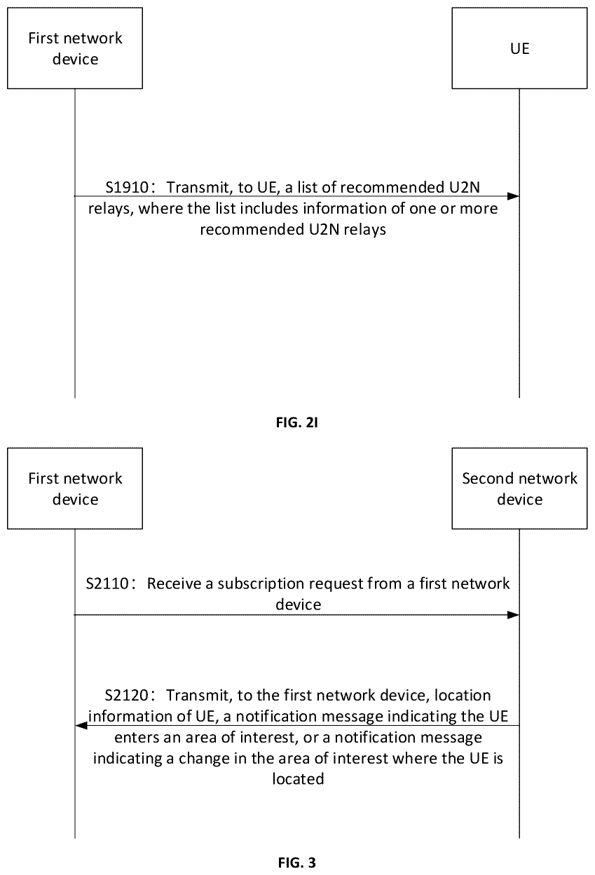

As shown in FIG. 6, in the mode B, the remote UE may automatically transmit the solicitation message, such as a UE-to-network (U2N) relay discovery solicitation message. If the solicitation message carries the information of the recommended U2N relay, a UE-to-network (U2N) relay discovery response message returned by the recommended U2N relay will be received.

The selection requirements for the relay UE may include at least one of the following: a 3GPP system shall support having preferences stored in an Evolved ProSe Remote UE related to the relay UE selection criteria, which may be configured/controlled by a home communication operator, and a final target U2N relay may be selected in combination with user's selections.

The following information is provided in the UE to support the UE in its role as a 5G ProSe U2N relay.

1) Authorization policy for acting as a 5G ProSe Layer-3 and/or Layer-2 U2N Relay when served by NG-RAN: PLMNs in which the UE is authorized to relay traffic for 5G ProSe Layer-3 and/or Layer-2 Remote UEs.

The authorization for a UE to act as a 5G ProSe U2N Relay also authorizes the use of 5G ProSe U2N Relay Discovery with a model a and a model b.

It is worth noting that: it is up to UE and application implementation to select a discovery model or whether to perform both models simultaneously.

2) U2N Relay Discovery policy/parameters for ProSe Relay, which may specifically include 5G ProSe relay discovery parameters provided by PCF, or issued by a mobile equipment (ME), or configured by a universal integrated circuit card (UICC).

5G ProSe UE-to-network relay discovery parameters may, for example, include user information ID, relay service codes, a UE-to-network relay indicator, and/or a control plane security indicator. When the UE receives the network relay indicator, the network relay indicator indicates whether a particular RSC provides a 5G ProSe Layer-2 or Layer-3 U2N relay service. If the discovery parameters include the control plane security indicator and are provided for the particular RSC, it indicates that a security mode configured for discovery between the remote UE and the U2N relay is a security mode based on a control plane (CP).

Default destination layer-2 ID(s) may be configured to transmit an announcement message for relay discovery and an additional information message for relay discovery, and receive a solicitation message for relay discovery, etc.

For 5G ProSe Layer-3 U2N, PDU session parameters may include: a PDU session type, a data network name (DNN), a session and service continuity (SSC) mode, single network slice selection assistance information (S-NSSAI), and/or access type priority, etc., which will be configured for a relay service for the relay service code (RSC) of each ProSe.

It is worth noting that, in addition to security parameters, the U2N relay discovery policy/parameters may be provided for 5G ProSe relay from a ProSe application server.

3) For 5G ProSe Layer-3 Relay and QoS mapping.

Each QoS mapping entry includes: a mapping between a 5QI value and a quasi-co-location indicator (PQI) value; a PQI packet delay budget (PDB) adjustment factor, for PC5 communication for the 5G ProSe Layer-3 U2N relay operation; and optionally, relay service codes associated with the QoS mapping entry.

4) For the 5G ProSe Layer-3 UE-to-network (U2N) relay, Ethernet traffic or unstructured traffic from the 5G ProSe Layer-3 remote UE is relayed by using an IP-type PDU session.

The address information of the ProSe service server for the ProSe service may include an IP address/FQDN and a transport layer port number.

5) Valid time indicates an expiration time of the policy/parameter for 5G ProSe U2N Relay discovery and communication; and if the valid time is exceeded, the U2N relay discovery and communication policy/parameters will become invalid. The U2N relay discovery and relaying/parameters here may be policy information in the foregoing embodiments.

The following information is provided for the remote UE to support the relay service of the remote UE, and for example, to support the remote UE to use the 5G ProSe U2N relay.

1) authorization policy information for using the 5G ProSe Layer-3 and/or Layer-2 U2N Relay, which may include, but is not limited to, at least one of: whether the 5G ProSe Layer-3 remote UE is authorized to use the 5G ProSe Layer-3 U2N relay; or whether the 5G ProSe Layer-2 remote UE is authorized to use the 5G ProSe Layer-2 U2N relay.

For example, the remote UE is authorized to use a network range of the U2N relay, where the network range includes, but is not limited to, a home public land mobile network (HPLMN) and/or a visited public land mobile network (VPLMN).

The 5G ProSe remote UE may also be authorized to use the 5G ProSe U2N relay discoveries in a mode a and a mode b.

2) The 5G ProSe relay discovery policy/parameters may further include: 5G ProSe relay discovery parameters, where the 5G ProSe relay discovery parameters may be transmitted by a network device or may be pre-configured on the UE, e.g., pre-configured for issuance in a mobile equipment (ME) or on a universal integrated circuit card (UICC). For example, the parameters, if the 5G ProSe relay discovery parameters are transmitted by the network device, the 5G ProSe relay discovery parameters may be issued by the PCF to the remote UE; 5G ProSe UE-to-network relay discovery parameters, where the relay discovery parameters may include user information ID, relay service codes, a UE-to-network (U2N) relay indicator, and/or a control plane security indicator; and a U2N relay indicator indicating whether a particular RSC provides a relay service for 5G ProSe Layer-2 or Layer-3 U2N. If the control plane security indicator is provided for a particular RSC, it indicates that a security procedure is executed on a control plane. If there is no control plane security indicator, the user plane is subjected to security processing.

Default destination layer-2 ID(s) may be configured to transmit a solicitation message for relay discovery and receive an announcement message and an additional information message for relay discovery, etc.

For a 5G ProSe Layer-3 UE-to-network relay, PDU session parameters (PDU session type, DNN, SSC mode, S-NSSAI, and access type priority) will be configured for relay traffic of each ProSe Relay service code, without using N3IWF access, or indication of N3IWF access; and for a 5G ProSe Layer-3 U2N relay, an optional ProSe application traffic descriptor is configured for the relay traffic of each ProSe Relay Service Code.

3) The N3IWF selection policy/parameters of a 5G ProSe Layer-3 remote UE may be as follows: the configuration of non-3GPP inter working function (N3IWF) identifiers, such as a fully qualified domain name (FQDN) or an Internet protocol (IP) address, of the 5G ProSe Layer-3 remote UE in a home public land mobile network (HPLMN).

Access node selection information for a 5G ProSe Layer-3 Ethernet relay is configured for a PLMN prioritized list for N3IWF selection, and further indicates whether the selection of an N3IWF in the PLMN is based on a tracking area identifier fully qualified domain name (FQDN) or on a communication operator identifier such as the FQDN.

It is worth noting that: the relay discovery parameters, except for the security parameters, may be provided by the ProSe Application Server to the 5G ProSe remote UE as the 5G ProSe Relay discovery policy/parameters. The security parameters may include the aforementioned network relay indicator and/or control plane security indicator. In other embodiments, the discovery policy/parameters may further include information such as a root key identifier for mutual discovery between the remote UE and the U2N relay. Here is an example, and the particular implementation is not limited to this example.

4) Valid time indicates that 5G ProSe U2N relay discovery and communication policy/parameters will become invalid if the valid time is exceeded.

The following information is provided in the UE to support the UE that plays the role of the 5G ProSe U2N relay, and provided in the UE to support the UE that plays the role of the 5G ProSe remote UE, allowing the use of the 5G ProSe U2N relay.

Radio parameters of the 5G ProSe relay discovery in a case of no NG-RAN service.

The radio parameters may include: radio parameters of new radio (NR) PC5 in a corresponding geographical area, which indicate whether the recommended U2N relay is managed by a communication operator or a non-communication operator.

In a case of no NG-RAN service, the UE may perform 5G ProSe direct discovery on a PC5 reference point using the radio parameters only when the UE is capable of being reliably located on the corresponding geographic area.

The default configuration of PC5 discontinuous reception (DRX) may be as follows.

The radio parameters of 5G ProSe relay communication in the case of no NG-RAN service may be as follows: the radio parameters may include: radio parameters of NR PC5 in the corresponding geographical area, which indicate whether the recommended U2N relay is managed by the communication operator or the non-communication operator. The UE performs 5G networking using the radio parameters, such that the UE may be reliably located itself in the corresponding geographical area.

It is worth noting that the validity time of these radio parameters is to the same as the validity time of the policy/parameters of the 5G ProSe UE-to-network Relay or the 5G ProSe remote UE. These radio parameters may also be referred to as radio frequency (RF) parameters.

Privacy-related policy/parameters may include: a privacy timer value, where the privacy timer value indicates the UE should change each source Layer-2 ID duration when privacy is required.

Since the selection of the 5G ProSe remote UE is performed by the 5G ProSe remote UE, the 5G ProSe remote UE may configure a list of recommended 5G ProSe U2N relays.

It is not possible to pre-configure the list of recommended 5G ProSe U2N relays in the ME or the USIM as the recommended 5G ProSe U2N relays varies depending on locations. Therefore, they should be dynamically provisioned based on the UE locations, and are not included in dynamically provided parameters.

The list of recommended 5G ProSe relays is provided for the remote UE. The relay list includes information of one or more recommended U2N relays.

The operator may configure the list of recommended 5G ProSe U2N relays for each location (e.g., an area of interest) in the PCF or UDR.

The PCF subscribes the AMF to a change in the area of interest of the UE, so that the AMF transmits a notification message to the PCF as the area of interest of the UE changes.

When the 5G ProSe remote UE travels to an area of interest that is identified by combining cell ID(s), base station ID(s) (e.g., gNB ID(s)), and tracking area ID(s) (TAI(s)), the AMF will detect that the UE enters the area of interest.

When the AMF notifies the UE of the change in the area of interest, the PCF updates the policy information/parameters of the 5G ProSe U2N relay with information provided in the UE, and provide the information of the recommended U2N relay, such that the use activated in 5G ProSe U2N based on the current area of interest of the UE becomes possible.

The PCF includes updated parameters in a UE policy container, and an establishment or modification process of UE policy association initiated by the PCF may transmit updated parameters to the 5G ProSe remote UE. When the 5G ProSe remote UE receives an updated list of recommended 5G ProSe network relays, the list will be stored for subsequent use.

When the 5G ProSe remote UE decides to connect to the network via the 5G ProSe U2N relay, relay discovery is performed, and one or more response messages are received from the candidate U2N relay. If the 5G ProSe remote UE stores the recommendation list, e.g., List of recommended 5G ProSe UE-to-network Relays, the selection of the 5G ProSe U2N relay should take into account the recommended U2N relays indicated by information of the recommended U2N relay included in the recommendation list.

For 5G ProSe relay discovery in the mode B, the remote UE carries information of the recommended U2N relay in the solicitation message for 5G ProSe relay discovery. Then, the candidate 5G ProSe UE-to-Network Relay matches the information of the recommended U2N relay and, if the match is successful, a response will be made and a response message will be sent, so that the remote UE will receive the response message.

The following parameters are added as part of the 5G ProSe relay discovery policy/parameters to support the UE in the role of the 5G ProSe remote UE as information provided in the UE, thereby enabling the 5G ProSe relay: a list of recommended 5G ProSe relays including user information ID, for the selection of the U2N relays.

The PCF provides the 5G ProSe remote UE with the list of recommended 5G ProSe U2N relays based on the current area of interest of the UE.

If there is a list of 5G ProSe U2N relays on the 5G ProSe U2N, this option should be considered in 5G ProSe U2N relay options.

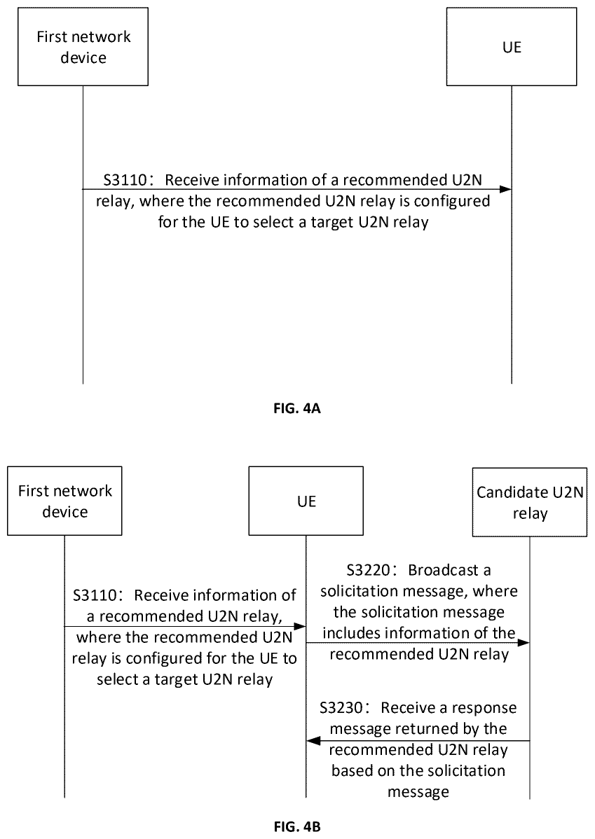

As shown in FIG. 7, an embodiment of the present disclosure provides a device for processing information 100. The device 100 includes: a first transmission module 110.

The first transmission module 110 is configured to transmit, to UE, information of a recommended UE-to-network (U2N) relay.

The device for processing information 100 may be a first network device.

In some embodiments, the first transmission module 110 may be a program module. The program module may be executed by a processor to implement the operations.

In other embodiments, the first transmission module 110 may further include a module in which hardware and software are combined. The module in which hardware and software are combined includes, but is not limited to: various programmable arrays. The programmable array includes, but is not limited to, a field-programmable array and/or a complex programmable array.

In other embodiments, the first transmission module 110 may be a pure hardware module. The pure hardware module includes, but is not limited to: an application-specific integrated circuit (ASIC).

In some embodiments, the first transmission module 110 is configured to transmit, to the UE, information of a recommended U2N relay within an area of interest.

In some embodiments, the device 100 further includes a first receiving module (not shown).

The first receiving module is configured to receive a notification message indicating the UE enters an area of interest, transmitted by a second network device; and/or receive a notification message indicating a change in the area of interest where the UE is located, transmitted by a second network device.

In some embodiments, the device 100 further includes: a second receiving module (not shown), configured to receive location information of the UE transmitted by the second network device; and a first determination module (not shown), configured to determine whether the UE is located in the area of interest based on the location information.

In some embodiments, the device 100 further includes: a second transmission module (not shown), configured to transmit a subscription request to the second network device, where the subscription request is configured to subscribe the second network device to the location information of the UE, the notification message indicating the UE enters the area of interest, and/or the notification message indicating the change in the area of interest where the UE is located.

In some embodiments, the area of interest is identified by at least one of: a cell identifier; a base station identifier; or a tracking area identifier.

In some embodiments, the first transmission module 110 is configured to transmit, to the UE, policy information including the information of the recommended U2N relay.

In some embodiments, the first transmission module 110 is configured to transmit, to the UE, a list of recommended U2N relays, where the list includes information of one or more recommended U2N relays.

In some embodiments, the recommended U2N relay may include at least one of: a U2N relay deployed by a communication operator; or a U2N relay recommended by the communication operator.

In some embodiments, the UE has a permission as a remote UE.

In some embodiments, the first transmission module 110 is configured to transmit, to the UE, the information of the recommended U2N relay when UE policy association is established; and/or transmit, to the UE, the information of the recommended U2N relay when UE policy association is updated.

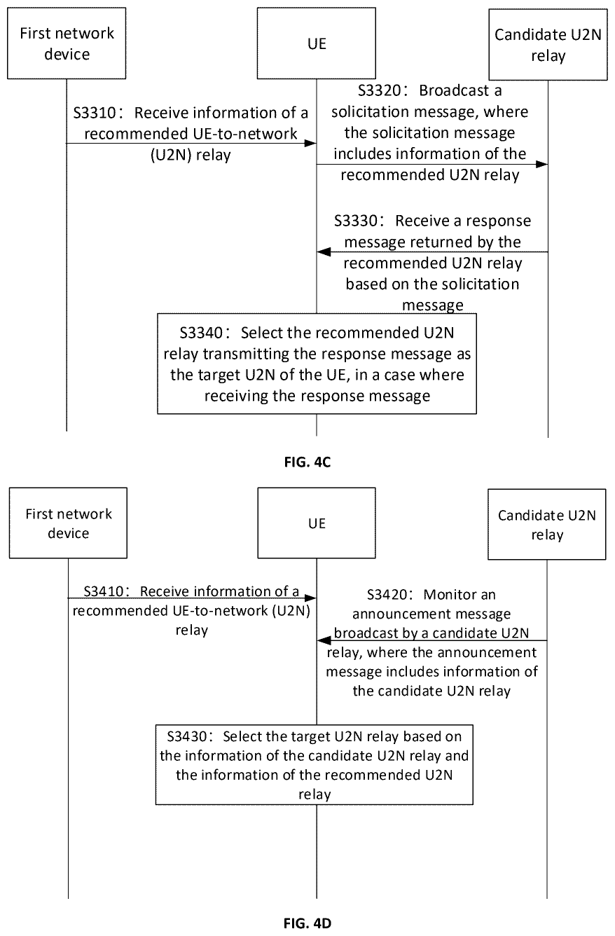

As shown in FIG. 8, an embodiment of the present disclosure provides a device for processing information 200. The device 200 includes: a third receiving module 210 and a third transmission module 220.

The third receiving module 210 is configured to receive a subscription request of a first network device.

The third transmission module 220, configured to transmit, to the first network device, location information of a UE, a notification message indicating the UE enters an area of interest, or a notification message indicating a change in the area of interest where the UE is located, where the location information of the UE, the notification message indicating the UE enters the area of interest, or the notification message indicating the change in the area of interest where the UE is located are configured for the first network device to provide, for the UE, information of a recommended U2N relay.

The device for processing information 200 may be a second network device. The second network device includes, but is not limited to, an AMF.

The third receiving module 210 and the third transmission module 220 may correspond to a network interface and/or a transmitting/receiving interface, etc.

The subscription request may subscribe the second network device such as PCF to the location information of the UE, the notification message indicating the UE enters the area of interest, the notification message indicating the change in the area of interest where the UE is located, and/or a notification message indicating the UE leaves the area of interest.

The subscription request may include a subscription indication configured to indicate location information of the UE located by the first network device relative to the second network device, the notification message indicating the UE enters the area of interest, or the notification message indicating the change in the area of interest.

In an embodiment, the subscription request may further include an identifier of the UE. The identifier of the UE may include: SUCI, SUPI or other identifiers.

In another embodiment, the subscription request may further include an area identifier of the area of interest of the UE.

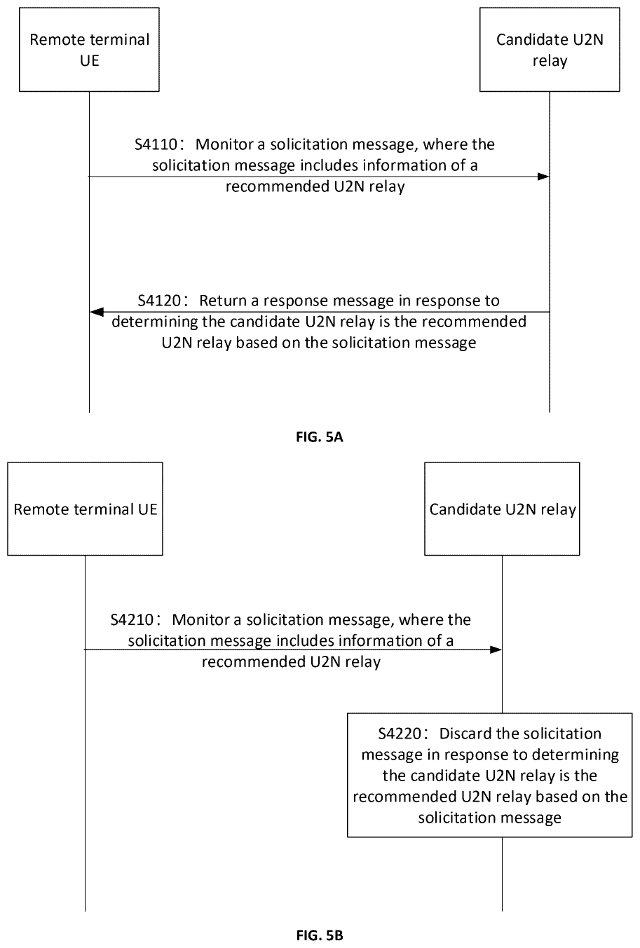

As shown in FIG. 9, an embodiment of the present disclosure provides a device for processing information 400. The device 400 includes: a fourth receiving module 410.

The fourth receiving module 410 is configured to receive information of a recommended UE-to-network (U2N) relay, where the recommended U2N relay is configured for the UE to select a target U2N relay.

An embodiment of the present disclosure provides a device for processing information. The device for processing information may be a remote UE.

In some embodiments, the fourth transmission module 410 may correspond to a transmitting/receiving antenna and/or a network interface, etc.

In some embodiments, the device for processing information 400 may further include a storage module (not shown). The storage module is connected to the fourth receiving module 410, and may be at least configured to store the information of the recommended U2N relay.

In some embodiments, the device 400 further includes: a first broadcasting module (not shown), configured to broadcast a solicitation message, where the solicitation message includes the information of the recommended U2N relay.

The fourth receiving module 410 is configured to receive a response message returned by the recommended U2N relay based on the solicitation message.

In some embodiments, the device 400 further includes: a first selection module (not shown), configured to select the recommended U2N relay transmitting the response message as the target U2N of the UE, in a case where receiving the response message.

In some embodiments, the device 400 further includes: a first monitoring module (not shown), configured to monitor an announcement message broadcast by a candidate U2N relay, where the announcement message includes information of the candidate U2N relay; and a second selection module (not shown), configured to select the target U2N relay based on the information of the candidate U2N relay and the information of the recommended U2N relay.

In some embodiments, the first selection module is configured to select the candidate U2N relay included in the recommended U2N relay as the target U2N of the UE.

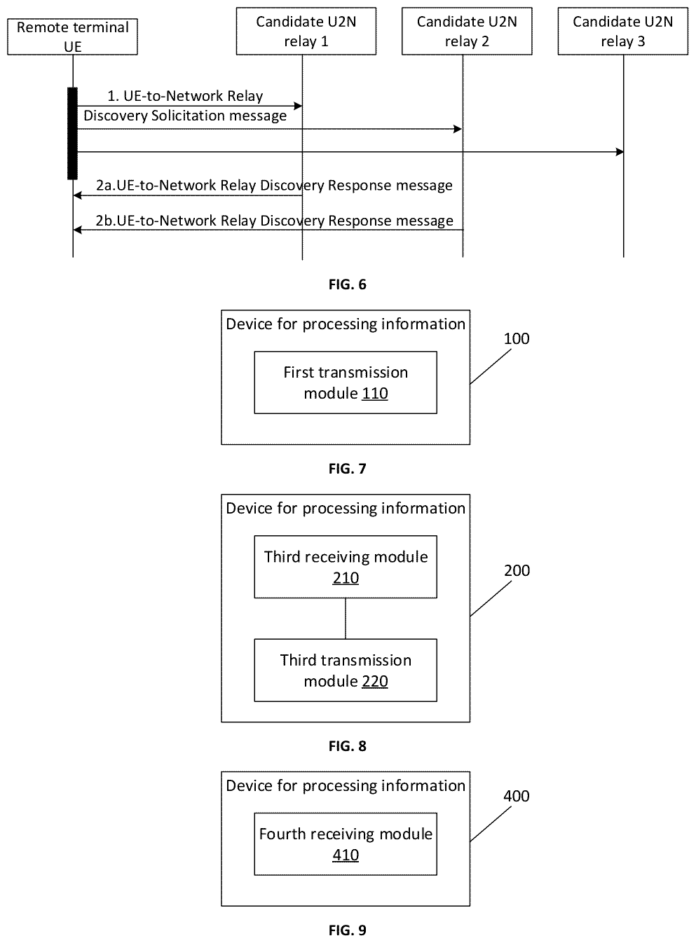

As shown in FIG. 10, an embodiment of the present disclosure provides a device for processing information 500. The device 500 includes: a second monitoring module 510 and a returning module 520.

The second monitoring module 510 is configured to monitor a solicitation message, where the solicitation message includes information of a recommended U2N relay.

The returning module 520 is configured to return a response message in response to determining the candidate U2N relay is the recommended U2N relay based on the solicitation message.

The second monitoring module 510 and the returning module 520 may be a transmitting/receiving antenna and/or a network interface, respectively.

In some embodiments, the device 500 further includes: a discarding module (not shown), configured to discard the solicitation message in response to determining the candidate U2N relay is the recommended U2N relay based on the solicitation message.

The discarding module may correspond to a processor, etc., and may be configured to discard the solicitation message, etc.

An embodiment of the present disclosure provides a communication device. The communication device includes: a memory, configured to store executable instructions of the processor; and a processor, connected to the memory, where the processor is configured to perform the method for processing information provided in any of the technical solutions.

The processor may include various types of storage medium. The storage medium may be a non-transitory computer-readable storage medium capable of continuing to memorize information stored thereon after the communication device is powered off.

Here, the communication device includes a UE or a network device. The network device includes, but is not limited to, a first network device to a second network device.

The processor may be connected to the memory via a bus, etc., and configured to read an executable program stored on the memory, where the processor, when running the executable program, is configured to implement any one of the method for processing information described, for example, at least one of the methods shown in FIG. 2A to FIG. 2I, FIG. 3, FIG. 4A to FIG. 4D, FIG. 5A to FIG. 5B, or FIG. 6.

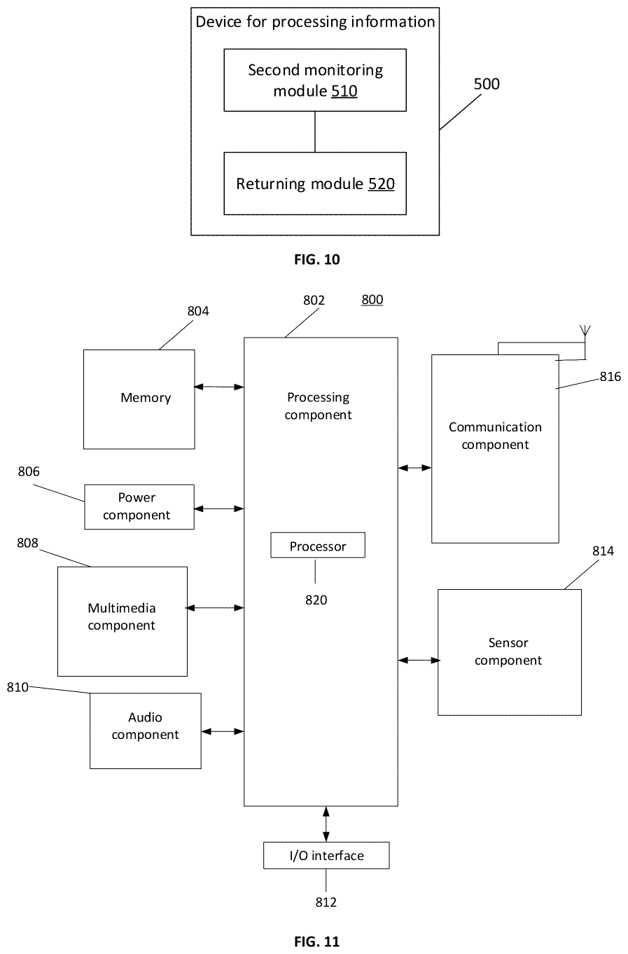

FIG. 11 is a block diagram of a UE 800 shown according to an example. For example, the UE 800 may be a mobile phone, a computer, a digital broadcast terminal device, a message transceiver device, a game console, a tablet device, a medical device, a fitness device, a personal digital assistant, or the like.

Referring to FIG. 11, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, telephone calls, data communications, camera operations, and recording operations. The processing component 802 may include one or more processors 820 to execute instructions to complete all or part of the steps of the method described. In addition, the processing component 802 includes one or more modules to facilitate interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, video, etc. The memory 804 may be implemented using any type of transitory or non-transitory memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disc or an optical disk.

The power component 806 provides power for various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, swipe, and gestures on the touch panel. The touch sensors may not only sense a boundary of a touch or swipe action, but also sense a wake-up time and a pressure associated with the touch or swipe action. In some embodiments, the multimedia component 808 includes a front camera and/or a rear camera. The front camera and/or the rear camera may receive external multimedia data while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output audio signals.

The I/O interface 812 provides an interface between the processing component 802 and peripheral interface modules, such as a keyboard, a click wheel, buttons, and the like. The buttons may include, but are not limited to, a home button, a volume button, a start button, and a lock button.

The sensor component 814 includes one or more sensors configured to provide state estimations in various aspects for the UE 800. For instance, the sensor component 814 may detect an on/off state of the device 800, relative positioning of components, e.g., the display and the keypad, of the UE 800, a change in location of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may further include a light sensor, such as a CMOS or CCD image sensor, for use in imaging applications. In some embodiments, the sensor component 814 may further include an accelerometer sensor, a gyroscope sensor, a magnetic sensor, a pressure sensor, or a temperature sensor.

The communication component 816 is configured to facilitate communication, wired or wirelessly, between the UE 800 and other devices. The UE 800 may access a wireless network based on a communication standard, such as WiFi, 2G, or 3G, or a combination of them. In one example, the communication component 816 receives a broadcast signal or broadcast associated information from an external broadcast management system via a broadcast channel. In an example, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the UE 800 may be implemented with one or more application particular integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the methods.

In an example, a non-transitory computer-readable storage medium including instructions is further provided, such as a memory 804 including instructions, which may be executed by a processor 820 of the UE 800 to generate the methods. For example, the non-transitory, computer-readable storage medium may be a ROM, a random access memory (RAM), a compact disc read-only memory (CD-ROM), a magnetic tape, a floppy disk, an optical data storage device, etc.

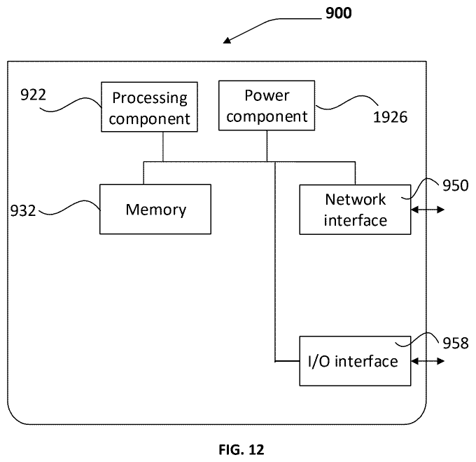

As shown in FIG. 12, an embodiment of the present disclosure shows a structure of an access device. For example, the communication device 900 may be provided as a network device. The network device may be the first network device and the second network device described.

Referring to FIG. 12, the network device 900 includes a processing component 922 which further includes one or more processors, and memory resources represented by a memory 932 for storing instructions executable by the processing component 922, such as applications. The applications stored in the memory 932 may include one or more modules, each corresponding to a set of instructions. In addition, the processing component 922 is configured to execute instructions to perform any method applied in the access device described in the methods, by using, e.g., at least one of the methods shown in FIG. 2A to FIG. 2I, FIG. 3, FIG. 4A to FIG. 4D, FIG. 5A to FIG. 5B, or FIG. 6.

The communication device 900 may further include a power component 1926 configured to perform power management of the communication device 900, one or more wired or wireless network interfaces 950 configured to connect the communication device 900 to a network, and one or more input/output (I/O) interfaces 958. The communication device 900 may operate based on an operating system stored in the memory 932, such as Windows Server™, Mac OS X™, Unix™, Linux™, FreeBSD™ or analogs.

Other embodiments of the present disclosure will be apparent to those skilled in the art from consideration of the specification and to practice the present disclosure herein. The present disclosure is intended to cover any variations, uses, or adaptations of the present disclosure, following the general principles thereof and including common knowledge or commonly used technical measures which are not disclosed herein. The specification and embodiments are to be considered as exemplary only, and the true scope and spirit of the present disclosure are indicated by the following claims.

It will be appreciated that the present disclosure is not limited to the exact construction that has been described and illustrated in the accompanying drawings, and that various modifications and changes can be made without departing from the scope thereof. The scope of the present disclosure is only limited by the appended claims.

1. A method for processing information, performed by a first network device, comprising:
transmitting, to a user equipment (UE), information of a recommended UE-to-network (U2N) relay.

2. The method according to claim 1, wherein transmitting, to the UE, the information of the recommended U2N relay comprises:
transmitting, to the UE, information of the recommended U2N relay within an area of interest.

3. The method according to claim 2, further comprising at least one of:
receiving a notification message indicating the UE enters the area of interest, transmitted by a second network device; or
receiving a notification message indicating a change in an area of interest where the UE is located, transmitted by a second network device.

4. The method according to claim 2, further comprising:
receiving location information of the UE, transmitted by a second network device; and
determining whether the UE is located in the area of interest based on the location information.

5. The method according to claim 3, further comprising:
transmitting a subscription request to the second network device, wherein the subscription request is configured to subscribe the second network device to at least one of location information of the UE, the notification message indicating the UE enters the area of interest, or the notification message indicating the change in the area of interest where the UE is located.

6. The method according to claim 2, wherein the area of interest is identified by at least one of:
a cell identifier;
a base station identifier; or
a tracking area identifier.

7. The method according to claim 1, wherein transmitting, to the UE, the information of the recommended U2N relay comprises:
transmitting, to the UE, policy information comprising the information of the recommended U2N relay, or
transmitting, to the UE, a list of recommended U2N relays, wherein the list comprises information of one or more recommended U2N relays.

8. (canceled)

9. The method according to claim 1, wherein the recommended U2N relay comprises at least one of:
a U2N relay deployed by a communication operator; or
a U2N relay recommended by a communication operator.

10. The method according to claim 1, wherein the UE has a permission as a remote UE.

11. The method according to claim 1, wherein transmitting, to the UE, the information of the recommended U2N relay comprises at least one of:
transmitting, to the UE, the information of the recommended U2N relay when UE policy association is established; or
transmitting, to the UE, the information of the recommended U2N relay when UE policy association is updated.

12. The method according to claim 1, further comprising:
receiving, by a second network device, a subscription request from the first network device; and
transmitting, to the first network device by the second network device, location information of the UE, a notification message indicating the UE enters an area of interest, or a notification message indicating an area of interest where the UE is located changes, wherein the location information of the UE, the notification message indicating the UE enters the area of interest, or the notification message indicating the change in the area of interest where the UE is located are configured for the first network device to provide, for the UE, the information of the recommended U2N relay.

13. A method for processing information, performed by a user equipment (UE), comprising:
receiving information of a recommended UE-to-network (U2N) relay, wherein the recommended U2N relay is configured for the UE to select a target U2N relay.

14. The method according to claim 13, further comprising:
broadcasting a solicitation message, wherein the solicitation message comprises the information of the recommended U2N relay; and
receiving a response message returned by the recommended U2N relay based on the solicitation message.

15. The method according to claim 14, further comprising:
selecting a recommended U2N relay transmitting the response message as the target U2N relay of the UE, in a case where receiving the response message.

16. The method according to claim 13, further comprising:
monitoring an announcement message broadcast by a candidate U2N relay, wherein the announcement message comprises information of the candidate U2N relay; and
selecting the target U2N relay based on the information of the candidate U2N relay and the information of the recommended U2N relay.

17. The method according to claim 13, wherein selecting the target U2N relay based on the information of the candidate U2N relay and the information of the recommended U2N relay comprises:
selecting the candidate U2N relay comprised in the recommended U2N relay as the target U2N relay of the UE.

18. A method for processing information, performed by a candidate user equipment-to-network (U2N) relay, comprising:
monitoring a solicitation message, wherein the solicitation message comprises information of a recommended U2N relay; and
returning a response message in response to determining the candidate U2N relay is the recommended U2N relay based on the solicitation message.

19.-23. (canceled)

24. A communication device, comprising one or more processors, a transceiver, a memory, and an executable program stored in the memory and runnable on the one or more processors, wherein the one or more processors, when running the executable program, are collectively configured to perform the method according to claim 1.

25. (canceled)

26. A communication device, comprising one or more processors, a transceiver, a memory, and an executable program stored in the memory and runnable on the one or more processors, wherein the one or more processors, when running the executable program, are collectively configured to perform the method according to claim 13.

27. A communication device, comprising one or more processors, a transceiver, a memory, and an executable program stored in the memory and runnable on the one or more processors, wherein the one or more processors, when running the executable program, are collectively configured to perform the method according to claim 18.
